(19) United States
(12) Patent Application Publication
(10) Pub. No.: US 2004/0147286 A1
(43) Pub. Date: Jul. 29, 2004

(54) System and method for controlling traffic distribution in a mobile communication system

(75) Inventors: Dong-Hee Kim, Seoul (KR); Hwan-Joon Kwon, Hwasung-gun (KR); Youn-Sun Kim, Seongnam-si (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/756,118

(22) Filed: Jan. 12, 2004

(30) Foreign Application Priority Data
Jan. 11, 2003 (KR) 1874/2003

(51) Int. Cl. H04Q 7/20

(52) U.S. Cl. 455/560; 455/561; 455/424

(57) ABSTRACT

A system for controlling a reverse data rate in a mobile communication system including a plurality of mobile stations, a plurality of base transceiver systems (BTSs) in communication with the mobile stations, and a base station controller (BSC) connected to the BTSs. The BSC detects handover states of the mobile stations, and controls a reverse data rate of a mobile station in a handover state. The BTS controls a reverse data rate of a mobile station in a non-handover state.

### PRIORITY

This application claims priority under 35 U.S.C. § 119 to an application entitled “System and Method for Controlling Traffic Distribution in a Mobile Communication System” filed in the Korean Intellectual Property Office on Jan. 11, 2003 and assigned Serial No. 2003-1874, the contents of which are incorporated herein by reference.

### BACKGROUND OF THE INVENTION

1. Field of the Invention

The present invention relates generally to a traffic control system and method in a mobile communication system, and in particular, to a system and method for controlling reverse traffic.

2. Description of the Related Art

Generally, in a mobile communication system, data transmission can be divided into forward data transmission and reverse data transmission. “Forward data transmission” refers to data transmission from a base station to a mobile station, while “reverse data transmission” refers to data transmission from a mobile station to a base station. According to the type of transmission data, mobile communication systems can be classified into systems supporting only a voice service, systems supporting a combination of a voice service and a simple data service, and systems supporting only a high-speed data service. The advent of such a mobile communication system providing a data service is the result of rapid development of mobile communication technology in answer to increasing users' demands for transmitting/receiving more information at higher speeds.

In such a mobile communication system processing data at high speed, reverse data traffic is transmitted over a packet data channel by the physical layer packet (PLP), and a length of the data traffic is fixed. Packets have a variable data rate, and a data rate of each packet is determined depending on power of a mobile station, an amount of transmission data, and a rate control bit (RCB) transmitted from a base station over a rate control channel (RCCH).

In addition, a data rate of a mobile station is determined by scheduling. A base station performs scheduling using RoT (Rise over Thermal) representing total reception power over thermal noises or a load obtained from a received signal-to-noise ratio of a mobile station belonging to a current base transceiver system (BTS). When RoT is available, scheduling is performed so that RoT is matched to a predetermined reference RoT level, and when RoT is unavailable, scheduling is performed so that a load is matched to a predetermined reference load level. For the convenience of explanation, RoT is used herein.

Thus, a scheduler in a base station determines whether to increase, decrease or hold a data rate of a corresponding mobile station, considering RoT, and a buffer status and a power status of each mobile station.

FIG. 1 is a diagram for explaining the configuration and operation scheme for controlling a mobile station in an existing system. As illustrated in FIG. 1, a base station (BS) is comprised of base transceiver systems (BTSs) and a base station controller (BSC). A BTS manages its cell(s), and a BSC is connected to a plurality of BTSs and controls the BTSs connected thereto. In addition, as illustrated in FIG. 1, each mobile station undergoes reverse data rate control from a BTS to which it belongs. A mobile station in a non-soft handover (non-SHO) state (hereinafter referred to as “non-SHO mobile station”) undergoes reverse data rate control from only a BTS to which it belongs, while a mobile station in a soft handover (SHO) state (hereinafter referred to as “SHO mobile station”) undergoes reverse data rate control from a plurality of BTSs in an active set. Herein, a non-SHO mobile station refers to a mobile station in a non-SHO state, while an SHO mobile station refers to a mobile station in an SHO state. In FIG. 1, mobile stations 111 and 113 each belonging to one BTS are controlled by their BTSs 101 and 102, respectively, and another mobile station 112 belonging to both BTSs becomes an SHO mobile station which is simultaneously controlled by the BTSs 101 and 102.

In an SHO mobile station controlled by a plurality of BTSs, reverse rate control messages received from the BTSs are different from each other. In this regard, a rate control procedure will now be described with reference to FIG. 1. A BTS#1 101 and a BTS#2 102 each transmit a rate control command to a mobile station according to their RoT conditions. For example, BTS#1 101 can send a rate-down command to the mobile station, while BTS#2 102 can send a rate-up command to the mobile station. In this case, the mobile station obeys a command from any one of the BTSs, and commonly, according to ‘Or-of-Down’ rule, the mobile station decreases it data rate if any one of the BTSs issues a rate-down command. This is because a scheduler in each BTS determines a data rate of each mobile station so that a received RoT maintains a reference RoT, and if a mobile station receiving a rate-down command increases its data rate, a received RoT of a corresponding BTS will undesirably exceed the reference RoT.

When a received RoT exceeding the reference RoT in a particular BTS, an increase in an interference level may occur, resulting in a reduction in throughput of a corresponding cell. Therefore, in order to secure stability of the entire system, if a mobile station receives different rate control commands from a plurality of BTSs, the mobile station determines whether there is any rate-down command among the received rate control commands. If there is any rate-down command, the mobile station decreases the current data rate and transmits data at the decreased data rate.

However, even the use of the ‘Or-of-Down’ rule cannot resolve the inefficiency problem. A scheduler in a BTS determines a data rate of each mobile station so that a received RoT maintains a reference RoT. However, if a mobile station receiving a rate-up command from a particular BTS decreases it data rate, a received RoT of the BTS becomes lower than a reference RoT. This means that available resources are not sufficiently utilized, also leading to a reduction in throughput of a corresponding cell.

Similar situations occur even in a case where reverse Hybrid Automatic Repeat and Request (HARQ) is used. A description will now be made of an operation performed in such a case. If reverse data is received, a BTS must transmit an ACK or NACK signal to a mobile station over an acknowledgment channel (hereinafter referred to as “ACK channel”). In the case where the mobile station is a non-SHO mobile station, a corresponding BTS determines an ACK or NACK signal and then transmits the determined signal. However, in the case where the mobile station is an SHO mobile station, signals received from respective BTSs connected to the mobile station can be different from each other. This will be described below with reference to FIG. 1. For example, BTS#1 101 can successfully receive a packet transmitted by the mobile station 112, while BTS#2 102 fails to receive the packet transmitted by the mobile station 112. In this case, BTS#1 101 transmits an ACK signal to the mobile station 112 and BTS#2 102 transmits a NACK signal to the mobile station 112. The mobile station 112 receiving such signals transmits the next packet because it received from BTS#1 101 an ACK signal indicating successful receipt of a previous packet. However, BTS#2 102 expects that the previous packet will be retransmitted, since it failed to successfully receive the previous packet, i.e., it transmitted a NACK signal to the mobile station 112. In this case, a signal for determining whether each cell has successfully received a packet is needed between BTS#1 101 and BTS#2 102. However, such signaling can act as an overhead. That is, when BTS#1 101 transmits ACK and BTS#2 102 transmits NACK, the mobile station 112 transmits a new packet since it received ACK, but BTS#2 102 expects retransmission of the previous packet. Therefore, for more accurate operation, it is necessary to inform BTS#2 that BTS#1 transmitted ACK, through signaling via a network.

### SUMMARY OF THE INVENTION

It is, therefore, an object of the present invention to provide a system and method for controlling traffic distribution so as to increase BTS efficiency during traffic control in a BTS and a BSC in a mobile communication system.

It is another object of the present invention to provide a system and method for transmitting a consistent control message to a mobile station in a mobile communication system.

It is a further object of the present invention to provide a system and method for efficiently controlling an SHO mobile station.

It is yet another object of the present invention to provide a system and method for increasing throughput of a BTS by transmitting a consistent control message to a mobile station in a mobile communication system using reverse HARQ.

To achieve the above and other objects, there is provided a system for controlling a reverse data rate in a mobile communication system including a plurality of mobile stations, a plurality of base transceiver systems (BTSs) in communication with the mobile stations, and a base station controller (BSC) connected to the BTSs. The BSC detects handover states of the mobile stations, and controls a reverse data rate of a mobile station in a handover state. The BTS controls a reverse data rate of a mobile station in a non-handover state.

To achieve the above and other objects, there is provided a method for controlling a reverse data rate of a mobile station by a base station controller (BSC) in a mobile communication system including a plurality of mobile stations, a plurality of base transceiver systems (BTSs) in communication with the mobile stations, and the BSC connected to the BTSs. The method comprises the steps of transmitting a reverse rate control suspend message for a particular mobile station to a BTS controlling a reverse data rate of the mobile station when handover of the mobile station is needed; and controlling a reverse data rate of the mobile station considering remaining capacity of BTSs in communication with the mobile station among BTSs included in an active set of the mobile station.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram for explaining the configuration and operation scheme for controlling a mobile station in an existing system;

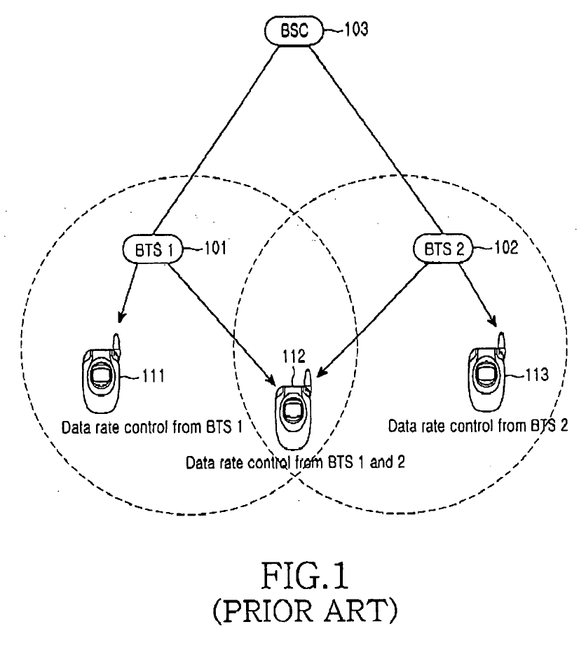

FIG. 2 is a block diagram illustrating control function blocks for explaining operations of BTSs and a BSC during rate control on an SHO mobile station and a non-SHO mobile station according to a preferred embodiment of the present invention;

FIG. 3 is a flowchart illustrating a procedure for performing handover of a mobile station in a BTS control function block according to a preferred embodiment of the present invention;

FIG. 4 is a flowchart illustrating a procedure for performing handover of a mobile station in a BSC control function block according to a preferred embodiment of the present invention; and

FIG. 5 is a block diagram illustrating structures of a BTS apparatus and a BSC apparatus according to a preferred embodiment of the present invention.

### DETAILED DESCRIPTION OF THE PREFERRED EMBODIMENTS

A preferred embodiment of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

In an embodiment of the present invention, a BSC performs rate control in an SHO state and rate control in a non-SHO state in a different manner. That is, rate control on an SHO mobile station is performed by a BSC, while rate control on a non-SHO mobile station is performed by BTSs. In the following description, the present invention will be applied to rate control. One of ordinary skill in the art will recognize that the invention can also be applied to response signal control. For this, a reverse control message is used. The reverse control message is classified into a rate control bit (RCB) which is a reverse rate control bit, and a grant message. The reverse rate control bit can be transmitted to instruct increase, decrease or hold of the current rate, or to instruct increase or decrease of the current rate. On the other hand, the grant message can be transmitted to instruct a corresponding mobile station to perform reverse control at a certain rate from the next slot. For example, if a mobile station, currently performing reverse transmission at 9.6 Kbps, receives a grant message granting transmission at 38.4 Kbps, the mobile station can perform reverse transmission at 38.4 Kbps, skipping the next rate of 19.6 Kbps. In the following description, RCB is used for reverse rate control. However, the grant message can also be used for reverse rate control.

In addition, a response signal (or ACK/NACK signal) can be included in the reverse control message. In some cases, a message received from a SHO mobile station via a particular BTS is good while a message received from the SHO mobile station via another BTS is bad. In this case, a BSC transmits an ACK signal, a response signal indicating ‘Good’ reception, to the SHO mobile station. A description of such an example will be made below.

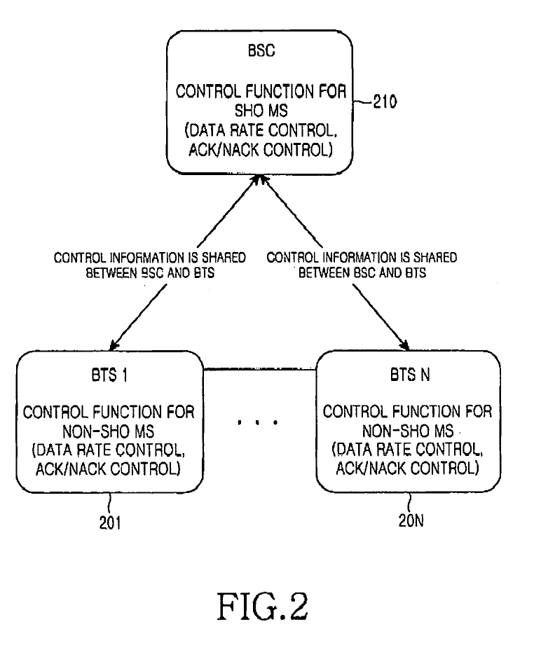

FIG. 2 is a block diagram illustrating control function blocks for explaining operations of BTSs and a BSC during rate control on an SHO mobile station and a non-SHO mobile station according to a preferred embodiment of the present invention. With reference to FIG. 2, a detailed description will now be made of control functions and other functions of BTSs and a BSC during rate control on an SHO mobile station and a non-SHO mobile station according to the present invention.

Respective reverse control function blocks 201, . . . , 20N of BTSs (hereinafter referred to as “BTS control function blocks”) perform reverse rate control on non-SHO mobile stations. Such rate control is performed in the existing method where a BTS controls a data rate of a mobile station. Therefore, signaling and call assignment on a non-SHO mobile station are performed by the BSC like in the existing method. However, the BTS control function blocks 201, . . . , 20N according to the present invention are designed not to perform reverse rate control on an SHO mobile station. A control function block 210 of a BSC (hereinafter referred to as “BSC control function block”) controls BTSs in the existing method. In addition, the BSC control function block 210 performs reverse rate control on an SHO mobile station according to the present invention. That is, the BSC control function block 210 controls a data rate of an SHO mobile station and controls transmission of a signal transmitted over an ACK channel.

A detailed description will now be made of operations of the BTS control function blocks 201, . . . , 20N and the BSC control function block 210 when a mobile station transitions from a non-SHO state to an SHO state.

When a mobile station is in a non-SHO state, i.e., when it belongs to only one BTS, the BTS control function block 201 allows the corresponding mobile station to undergo reverse data rate control only from that BTS. That is, the BTS control function block 201 generates a rate control bit and an ACK bit, and transmits them to the mobile station. However, various functions such as call-in, call-out, signaling, data rate control, and ACK/NACK detection from a received signal, are controlled by a BSC like in the existing method.

In the meantime, if the mobile station transitions to an SHO state, the BTS control function block 201 generates information on a handover action time and an active set of a mobile station, and transmits the generated information to the corresponding mobile station. In addition, since subsequent control is performed by the BSC, the BSC control function block 210 determines whether assignment of a new rate control channel is needed. At the same time, the BSC control function block 210 determines whether assignment of an ACK channel is necessary. As a result of the determinations, if new channels are needed, the BSC control function block 210 generates new rate control channel information and new ACK channel information, and sends the generated channel information to the mobile station. Since the BTS control function block 201 cannot know the states of other BTSs, the BSC control function block 210 determines whether to assign new channels, and if assignment of new channels is required, the BSC control function block 210 controls the BTS so as to set up new channels to the mobile station transitioning to the SHO state. In other words, the BTS forms a message using handover action time information, active set information and new channel assignment information received from the BSC control function block 210, and transmits the formed message to the corresponding mobile station. As a result, new channels are assigned between the BTS and the mobile station.

Next, a description will be made of a control operation when the SHO mobile station enters the area of a particular BTS, ending its SHO state. When the SHO mobile station enters the area of a particular BTS, i.e., when handover is ended, the BSC control function block 210 instructs a corresponding BTS control function block to which the mobile station belongs to individually control a reverse data rate of the mobile station. A description will now be made of an operation performed in such a case.

A delay time of a control message transmitted to a mobile station that undergoes reverse data rate control from the BSC control function block 210 is different from a delay time of a control message transmitted to a mobile station that undergoes reverse data rate control from a BTS. When a mobile station receives reverse rate control information from a BSC, a delay of about 2 frames occurs. Here, the “frame” becomes a data transmission unit for the reverse rate control information transmitted over a forward rate control channel. Therefore, when the mobile station is subject to reverse data rate control from the BSC, an ACK/NACK signal transmitted over an ACK channel may suffer transmission failure. For example, assuming that a BTS generates and transmits an ACK/NACK signal in answer to a signal received from a mobile station within a time of 2 frames (or 1 frame), if the BTS transmits a NACK signal responsive to data received at a current time (time #1) to the mobile station at a particular time (time #2), the mobile station retransmits a corresponding frame at a time #3 in response to the NACK signal received. The time #1, the time #2 and the time #3 occur in sequence. Therefore, each of the times can be either a transmission time in an air state, or a time required when determining a type of received information after completing error check on a received frame.

However, since the SHO mobile station is subject to reverse data rate control from the BSC, a longer delay time occurs than when the mobile station undergoes reverse data rate control by the BTS. Actually, a time delay of at least 1 frame occurs when a signal is transmitted from a mobile station to a BSC via a BTS and then a NACK signal responsive to the corresponding signal is generated by the BSC and transmitted to the mobile station via the corresponding BTS. That is, if the BSC generates a NACK signal in response to a reception signal transmitted 1 frame ahead of the current time (or time #1) and transmits the generated NACK signal to a corresponding mobile station, the mobile station retransmits a corresponding frame at the time #3. In this case, if handover has ended, the BSC transmits an ACK/NACK signal to the mobile station in response to a previous frame, and the corresponding BTS controls a data rate of the mobile station from the time when handover ended. Therefore, when the BSC transmits an ACK/NACK signal to the mobile station in response to a frame received at a previous time, the BTS transmits an ACK/NACK signal in response to a frame received after handover ended. In this case, the mobile station receives retransmission requests for different data frames at the same time, so the ACK/NACK signal received from the BSC collides with the ACK/NACK signal received from the BTS.

Generally, a delay time of a control message transmitted when a mobile station is controlled by a BSC is longer than that of a control message transmitted when the mobile station is controlled by a BTS. Therefore, if a mobile station transitions from a non-SHO state to an SHO state, a transmission time of an ACK/NACK signal becomes longer. In this case, the ACK/NACK signal is normally transmitted regardless of whether the mobile station is assigned a new channel or uses an existing channel. However, if the mobile station transitions from the SHO state to the non-SHO state, a transmission time of an ACK/NACK signal becomes shorter. Therefore, if the existing channel is used, the BTS and the mobile station both should transmit ACK/NACK signals for two packets at the same time, which is undesirable.

In this case, in the embodiment of the present invention, packet transmission is suspended for a period as much as a difference in a transmission time of the ACK/NACK signal between the BTS and the BSC. In an alternative method, when the mobile station transitions from the non-SHO state to the SHO state, the BTS assigns a new ACK channel to the corresponding mobile station. In this way, a response (ACK/NACK) signal generated while the mobile station undergoes data rate control from the BSC is transmitted over an ACK channel assigned when the mobile station undergoes data rate control by the BTS, and a response signal for a new packet is transmitted over an ACK channel newly assigned by the current BTS. In the latter method, the mobile station has two ACK channels corresponding to a transmission delay time between the BTS and the BSC, and the BTS must hold the two ACK channels assigned to the mobile station.

A description will now be made of an operation of the BSC control function block 210 according to above-stated two embodiments of the present invention. The BSC control function block 210 performs a general control function. In an SHO state, when an inquiry about whether assignment of a new channel to an SHO mobile station is needed is received from the BTS control function block 201, the BSC control function block 210 checks a state of target BTSs to which a call is to be handed over, and then sends the result information to the inquiring BTS. In addition, if a reverse rate control request for the SHO mobile station is received from the BTS control function block 201, the BSC control function block 210 controls a data rate of the SHO mobile station considering a resource state of the corresponding BTSs. Furthermore, the BSC control function block 210 symbol-combines packets received from the mobile station via a source BTS that will hand over a current call and target BTSs to which the call is to be handed over, and checks whether the combined received packet is good or bad. If the received packet is good, the BSC control function block 210 transmits an ACK signal over an ACK channel set up between each BTS in the handover operation and the mobile station, and if the received packet is bad, the BSC control function block 210 transmits a NACK signal over the ACK channel set up between each BTS in the handover operation and the mobile station.

Thereafter, if handover of the mobile station has ended, the BSC control function block 210 transmits an ACK/NACK signal for the packet received from a corresponding mobile station to the mobile station over a channel that was set up during handover. In a first embodiment of the above-stated two embodiments, the BSC control function block 210 controls a BTS so as to suspend reverse data transmission between the BTS and the mobile station for a predetermined time. Unlike this, in the second embodiment, the BSC control function block 210 transmits an ACK/NACK signal over a separate channel instead of a channel which was in the handover operation, as a channel for ACK/NACK transmission between the mobile station and the BTS. After an ACK signal for a final frame received from the BSC is transmitted, the channel is released. However, the channel transmitting an ACK/NACK signal, set up between the BTS currently controlling the mobile station and the BSC, is continuously held. The BSC control function block 210 instructs the BTS control function block 201 to control a reverse data rate of the handover-ended mobile station.

When the BSC controls a data rate of an SHO mobile station in this way, a BTS subtracts capacity corresponding to a data rate of a corresponding mobile station from the total capacity and controls a data rate of mobile stations in its area based on RoT or load at the remaining capacity, thus contributing to an increase in throughput of the BTS. In addition, BTSs are prevented from transmitting different ACK/NACK signals to the SHO mobile station, contributing to an increase in BTS efficiency and making it possible to easily control the mobile station.

As a BSC controls an SHO mobile station, a mobile station is not separately controlled by a plurality of BTSs included in its active set, and receives the same signal from the BTSs by the BSC. Therefore, it is possible to increase reception capability of packet data and an ACK/NACK channel signal through soft-combining on the received signals.

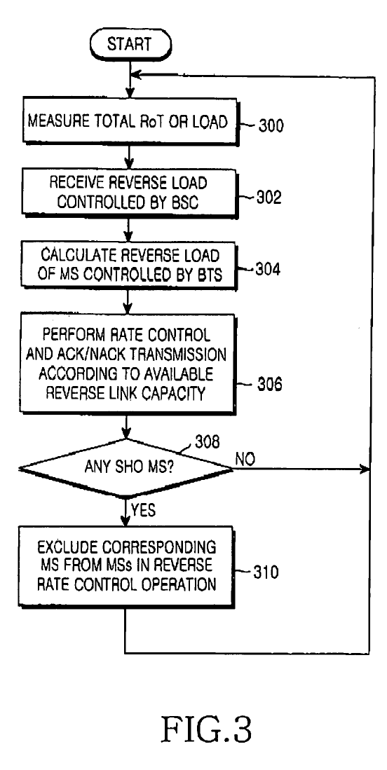

FIG. 3 is a flowchart illustrating a procedure for performing handover of a mobile station in a BTS control function block according to a preferred embodiment of the present invention.

In step 300, the BTS control function block 201 measures the total RoT or a load of a BTS. The total RoT can be measured at a predetermined time, and the load can be calculated by the BTS depending on a state of the current reverse link. Therefore, when the load is used for control, the BTS control function block 201 continuously measures the load, and when control is performed based on RoT, the BTS control function block 201 measures the RoT every predetermined time.

When measurement of RoT is completed or calculation of a load is completed, the BTS control function block 201 proceeds to step 302. In step 302, the BTS control function block 201 receives a reverse load of a mobile station controlled by a BSC because handover is in progress. The reverse load is a value received from a BSC, and the BSC provides this information to the BTS continuously or at stated periods. Therefore, in step 304, the BTS receiving the reverse load calculates reverse loads of non-SHO mobile stations, i.e., mobile stations whose reverse data rates are controlled by the BTS control function block 201 according to the present invention.

Thereafter, the BTS control function block 201 proceeds to step 306. In step 306, the BTS control function block 201 calculates capacity of a currently available reverse link from the value determined in steps 300 to 304. In addition, the BTS control function block 201 controls a reverse data rate of a non-SHO mobile station controlled by a BTS according to the currently available reverse link. Furthermore, in step 306, the BTS control function block 201 transmits a response (ACK/NACK) signal for a reverse packet received from a mobile station. The BTS control function block 201 determines in step 308 whether a message indicating occurrence of a handover state for a mobile station controlled by the BTS is received from the BSC. If it is determined in step 308 that there is a mobile station in an SHO state, the BTS control function block 201 proceeds to step 310 where it excludes the corresponding mobile station from mobile stations whose reverse rates are being controlled. That is, reverse rate control by the BTS is suspended. Thereafter, the BTS control function block 201 returns to step 300, and measures RoT or a load. When the BTS control function block 201 operates based on RoT, if the current time is not a predetermined RoT measurement time, the BTS control function block 201 proceeds to step 302 without performing the measurement of RoT or a load. In this manner, rapid reverse rate control can be performed on a mobile station in communication with only a BTS. Also, at step 308, if it is determined that there are no mobile stations in an SHO state, the process returns to step 300.

Meanwhile, though not illustrated in FIG. 3, when a particular mobile station controlled by a BSC enters a particular BTS, there is a case where reverse rate control should be performed on the mobile station. In this case, the BTS measures RoT or load of the corresponding mobile station during RoT measurement or load measurement of step 300, and performs reverse rate control on the mobile station. In addition, for such a rate control time, a separate channel can be used or a method of suspending reverse transmission for a predetermined time can be used.

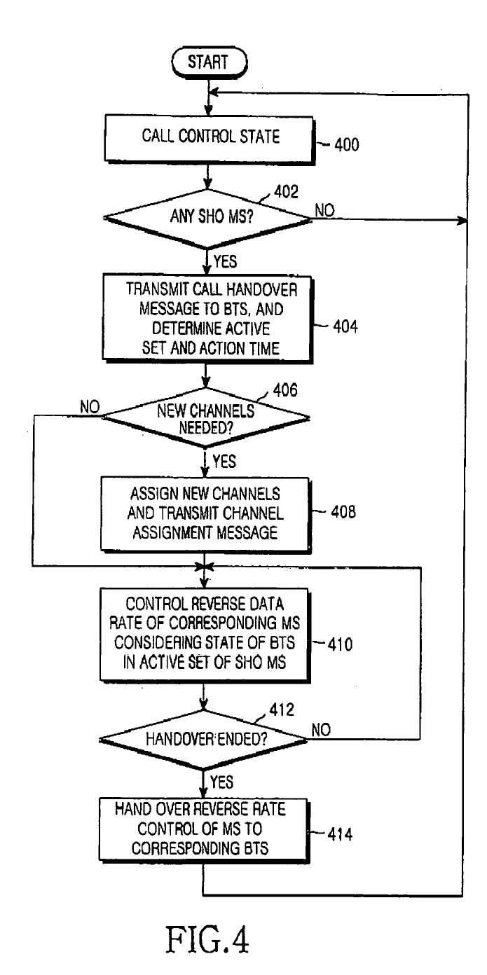

FIG. 4 is a flowchart illustrating a procedure for performing handover of a mobile station in a BSC control function block according to a preferred embodiment of the present invention.

In step 400, the BSC control function block 210 holds a call control state. Here, “call control state” refers to a state in which transmission of call assignment and control messages for a mobile station is controlled through a BTS, and according to the present invention, reverse rate control for a non-SHO mobile station is not included. For such mobile stations, reverse rate control is performed in the BTS as described in conjunction with FIG. 3. Holding such a call control state, the BSC control function block 210 proceeds to step 402 where it determines whether there is a mobile station in an SHO state. If it is determined in step 402 that there is a mobile station in an SHO state, the BSC control function block 210 proceeds to step 404, and otherwise, the BSC control function block 210 returns to step 400.

In step 404, the BSC control function block 210 transmits a call handover (or call transfer) message to the BTS. That is, the BSC control function block 210 transmits to a corresponding BTS a message for suspending reverse rate control on a mobile station controlled by the BTS. Furthermore, in step 404, the BSC control function block 210 determines an active set and a handover action time of the mobile station to be handed over (i.e., an SHO mobile station). Thereafter, in step 406, the BSC control function block 210 determines whether assignment of a reverse rate channel and an ACK channel for transmitting an ACK/NACK signal is needed for the SHO mobile station. If it is determined in step 406 that channel assignment is necessary, the BSC control function block 210 proceeds to step 408, and otherwise, the BSC control function block 210 proceeds to step 410.

In step 408, the BSC control function block 210 assigns new channels to the SHO mobile station, and transmits a channel assignment message via a BTS currently in communication with the mobile station in order to inform the mobile station of the newly assigned channels.

Thereafter, in step 410, the BSC control function block 210 controls a reverse data rate of the SHO mobile station considering states of BTSs in communication with the SHO mobile station among BTSs included in the active set of the SHO mobile station. At this point, an ACK/NACK signal received from the mobile station is also transmitted to the BSC without being processed in the BTS. Therefore, the BSC control function block 210 performs data retransmission or new data transmission depending on information received from the mobile station.

As the SHO mobile station is controlled by the BSC, the mobile station can receive a consistent ACK signal, and since the mobile station receives the same message, the mobile station can increase reception probability by soft-combining the received message.

After performing rate control on a reverse link of a particular mobile station in step 410, the BSC control function block 210 proceeds to step 412 where it determines whether handover of the SHO mobile station is ended. That is, the BSC control function block 210 determines whether the mobile station enters the area of a particular BTS and performs communication only in the BTS. If it is determined in step 412 that handover is ended, the BSC control function block 210 proceeds to step 414 where it generates a control handover (or control transfer) message for instructing a BTS where the mobile station is located to perform reverse rate control, and delivers the generated control handover message. Therefore, if handover of the mobile station is ended, transmission control on a reverse rate and an ACK signal is handed over to another BTS by the particular BTS. After the step 414, the BSC control function block 210 returns to step 400. At step 412, if it is determined that handover has not ended, the process returns to step 410.

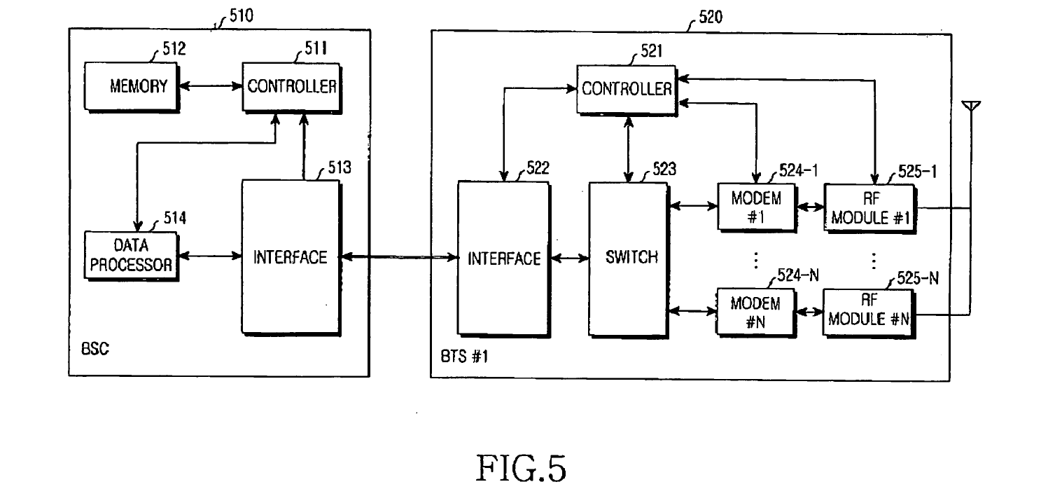

Next, with reference to FIG. 5, a description will be made of the connection between a BTS apparatus and a BSC apparatus, and their internal structures. FIG. 5 is a block diagram illustrating internal structures of a BTS apparatus and a BSC apparatus according to a preferred embodiment of the present invention.

In FIG. 5, reference numeral 510 represents an internal structure of a BSC apparatus, and reference numeral 520 represents an internal structure of a BTS apparatus. It should be noted that only the essential elements associated with the present invention are shown in FIG. 5.

First, a description will be made of internal structure and operation of the BSC 510. A controller 511 of the BSC 510 includes the BSC control function block 210 described in connection with FIG. 2, and thus performs a control operation according to the present invention. Data needed in the controller 511 is stored in a memory 512. That is, the memory 512 stores data needed for performing the procedure of FIG. 4. In addition, the memory 512 stores various data necessary for controlling an SHO mobile station. Using such data, the controller 511 generates a message for controlling a corresponding mobile station, or a message for controlling a corresponding BTS. A data processor 514 divides forward data to be transmitted to a particular mobile station in a proper size, or combines data received from the mobile station to transmit it to an upper layer. An interface 513 performs interfacing on data exchanged between the BSC 510 and the BTS 520.

Next, a description will be made of internal structure and operation of the BSC 520. The BTS 520 includes an interface 522 for performing interfacing on data received from the BSC 510, and a controller 521 for performing a control operation according to the present invention. The controller 521 includes the BTS control function block described in connection with FIG. 2. Thus, the controller 521 performs reverse control on only a non-SHO mobile station. Even when reverse control is performed by the BSC 510, a message is actually transmitted from the BTS 520 to a mobile station. Therefore, when a request for transmission of a control message for an SHO mobile station is received from the BSC 510, the controller 521 generates a control message. Alternatively, however, the BSC 510 can directly generate such a message and transmit the generated message.

A switch 523 performs a switching operation for transmitting forward data to be transmitted to each mobile station or reverse data received from each mobile station to the interface 522, and transmitting data received from the controller 521 to the BSC 510. In some cases, the switch 523 can be implemented with dedicated lines. However, it is implemented herein with a general switch. Data to be transmitted to a particular mobile station is processed in a modem section 524 and a radio frequency (RF) section 525. The processed data is transmitted to a mobile station via an antenna. The modem section 524 and the RF section 525 include N modems 524-1 to 524-N and N RF modules 525-1 to 525-N, respectively, and each modem-RF module pair is associated with its corresponding mobile station. The modem section 524 encodes and modulates data to be transmitted in a forward direction, and demodulates and decodes data received in a reverse direction. The RF section 525 performs up-conversion and power amplification to transmit forward transmission data to a corresponding mobile station, and performs low-noise amplification and down-conversion on reverse reception data to generate a baseband signal. The modem section 524 and the RF section 525 constitute a packet transceiver. During handover of a mobile station, the BSC 510 and the BTS 520 perform the control operation described in connection with FIGS. 2 to 4, so a detailed described thereof will be omitted for simplicity.

As described above, mobile stations are divided into a mobile station whose handover is performed by the BSC and a mobile station whose handover is not performed by the BSC, to control reverse traffic on a distributed basis. In this case, the same control information can be transmitted to the mobile station. In addition, rate control on an SHO mobile station and transmission of a signal for HARQ become simple. Moreover, a non-SHO mobile station undergoes reverse rate control from a BTS, thus contributing to rapid rate control.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for controlling a mobile station by a base station controller (BSC) in a mobile communication system including a first base transceiver system (BTS), a second BTS being adjacent to the first BTS, the mobile station in a handover region commonly occupied by the first and second BTSs, and the BSC connected to the first and second BTSs, the method comprising the steps of:
detecting a mobile station in a handover state;
generating a rate control message for a particular mobile station in a handover state; and
transmitting the generated control message to the first and/or second BTSs.

2. The method of claim 1, wherein the rate control message is an rate information message indicating a reverse data rate not exceeding a maximum data rate transmitted by the mobile station, via any one of the first and second BTSs.

3. The method of claim 2, wherein the rate control message is a message indicating an increase or a decrease in a maximum data rate transmitted from the mobile station.

4. The method of claim 2, wherein the rate control message is a message indicating an increase, a decrease or a hold of a rate the mobile station.

5. The method of claim 2, wherein the rate control message is generated depending on Rise over Thermal (RoT) of the BTSs.

6. The method of claim 2, wherein the rate control message is generated according to status information of a buffer in the mobile station.

7. The method of claim 2, wherein the rate control message is generated depending on available transmission power of the mobile station.

8. The method of claim 1, further comprising the step of transmitting a message requesting handover of control on the mobile station to the BTS along with the reverse control message.

9. The method of claim 8, wherein the message requesting handover of control on the mobile station includes control time information of the BTS.

10. The method of claim 1, further comprising the step of transmitting a rate control request message for handing over control on the mobile station to a BTS in which the mobile station is included, when handover of the mobile station is ended.

11. The method of claim 10, further comprising the step of suspending the rate control message transmission to a BTS in which the mobile station is included, for a predetermined time, when handover of the mobile station is ended.

12. A method for controlling a mobile station by a base station controller (BSC) in a mobile communication system including a first base transceiver system (BTS), a second BTS being adjacent to the first BTS, the mobile station in a handover region commonly occupied by the first and second BTSs, and the BSC connected to the first and second BTSs, the method comprising the steps of:
detecting a mobile station in handover states;
generating a ACK or NACK control message for a particular mobile station in a handover state; and
transmitting the generated ACK or NACK control message to the first and/or second BTSs.

13. The method of claim 12, further comprising the step of generating and transmitting the ACK control message when packet data received from any one of the BTSs for packet data transmitted in a reverse direction by the mobile station is good.

14. The method of claim 12, further comprising the step of generating a ACK suspend message which instructs BTS to suspend the ACK or NACK control message transmission on the mobile station.

15. The method of claim 12, further comprising the step of generating a reverse ACK request message which instructs BTS to control the ACK or NACK control message for the non-handover state.

16. A method for controlling a mobile station by a base station controller (BSC) in a mobile communication system including a first base transceiver system (BTS), a second BTS being adjacent to the first BTS, a mobile station in a handover region commonly occupied by the first and second BTSs, and the BSC connected to the first and second BTSs, the method comprising the steps of:
receiving a maximum data rate transmitted by the mobile station, via one of the first and second BTSs; and
determining one of data rates not exceeding the maximum data rate, and transmitting the selected data rate to the first and/or second BTSs.

17. The method of claim 16, wherein the maximum data rate is determined based on power status, buffer status and throughput of all mobile stations.

18. The method of claim 16, further comprising the step of if handover of the mobile station is needed, transmitting a handover action time information which the mobile station is to be handed over to the first and second BTSs.

19. The method of claim 16, further comprising the step of handing over reverse rate control to a BTS in which the mobile station is included, when handover of the mobile station is ended.

20. The method of claim 16, further comprising the step of the first and/or second BTSs for receiving the rate control determined from the BSC; and BTSs for generating the rate control bit (RCB) on the mobile station in the handover state and transmitting the generated the rate control bit for controlling the data rate of the mobile station.

21. The method of claim 20, wherein the rate control bit is transmitted over a rate control channel (RCCH).

22. A system for controlling a reverse data rate in a mobile communication system including a plurality of mobile stations, a plurality of base transceiver systems (BTSs) in communication with the mobile stations, and a base station controller (BSC) connected to the BTSs, the system comprising:
the BSC for detecting handover states of the mobile stations, and controlling a data rate of a mobile station in a handover state; and
a BTS for controlling a data rate of a mobile station in a non-handover state.

23. The system of claim 22, wherein if a handover state occurs in any one of the mobile stations undergoing reverse rate control from the BTS connected to the BSC, the BSC instructs the BTS to suspend reverse rate control on the mobile station, and controls the reverse rate of the mobile station.

24. The system of claim 23, wherein the BTS suspends reverse rate control on the mobile station upon receiving a reverse rate control suspend message from the BSC.

25. The system of claim 22, wherein the BSC sends a reverse rate control request message to the BTS where the mobile station is located, if a handover state of the mobile station is ended.

26. The system of claim 25, wherein upon receiving the reverse rate control request message for a particular mobile station, the BTS waits a predetermined time and then performs the reverse rate control on the mobile station.

27. The system of claim 26, wherein the predetermined time is a transmission delay time of traffic and a control signal from the BSC to the mobile station.

28. The system of claim 25, wherein upon receiving the reverse rate control request message for the particular mobile station, the BTS assigns a new channel to the mobile station and controls the reverse rate of the mobile station.

29. The system of claim 22, wherein the BSC generates a reverse data rate control for the mobile station in a handover state and transmits the reverse data rate control to the mobile station.

30. The system of claim 29, wherein the reverse data rate control is determined based on power status, buffer status and throughput of all mobile stations.

31. The system of claim 22, wherein the BTS generates a reverse data rate control and transmits the reverse data rate control for the mobile station in a non-handover state.

32. A method for controlling a reverse data rate of mobile stations by a base transceiver system (BTS) in a mobile communication system including a plurality of mobile stations, a plurality of BTSs in communication with the mobile stations, and a base station controller (BSC) connected to the BTSs, the method comprising the steps of:
measuring a load of mobile stations controlled by a BTS, and receiving from the BSC a load of mobile stations controlled by the BSC; and
controlling a reverse rate of a mobile station in a non-handover state using the load received from the BSC and the BTS

33. The method of claim 32, further comprising the step of controlling a rate of a mobile station in a non-handover state in the BTS, including the mobile stations, upon receiving a rate control request message for a particular mobile station from the BSC.

34. The method of claim 32, further comprising the step of controlling a rate of a mobile station that received a rate control request message from the BSC, after waiting a predetermined time.

35. The method of claim 34, wherein the predetermined time is a transmission delay time of traffic and a control signal from the BSC to the mobile station.

36. The method of claim 33, wherein the rate control request message is to be transmitted the BTSs where the mobile station is located, if a handover state of the mobile station is ended.

37. The method of claim 33, further comprising the step of assigning a new channel to the mobile station and controlling the rate of the mobile station upon receiving the rate control request message from the BSC.

38. An apparatus for controlling a mobile station in a base station controller (BSC) in a mobile communication system including a first base transceiver system (BTS), a second BTS being adjacent to the first BTS, a mobile station in a handover region commonly occupied by the first and second BTSs, and the BSC connected to the first and second BTSs, the apparatus comprising:
a memory for storing mobile station information and load information of each mobile station from each BTS; and
a controller for generating a reverse control message using the mobile station information and the load information of each mobile station, stored in the memory, and transmitting the generated rate control message to the BTSs.

39. The apparatus of claim 38, wherein a reverse control message is a rate control suspend message which transmits to the BTSs if handover of the mobile station is detected.

40. The apparatus of claim 38, wherein a reverse control message is a reverse data rate information for controlling on the mobile station in the handover state.

41. The apparatus of claim 38, wherein a reverse control message is an ACK or NACK information for controlling on the mobile station in the handover state.

42. The apparatus of claim 38, wherein the mobile station information includes buffer information and/or mobile station's transmission power information stored in the mobile station.

43. The apparatus of claim 38, further comprising an interface for transmitting an output of the controller to the BTSs.

44. An apparatus for controlling a mobile station in a base transceiver system (BTS) in a mobile communication system including a first BTS, a second BTS being adjacent to the first BTS, a mobile station in a handover region commonly occupied by the first and second BTSs, and a base station controller (BSC) connected to the first and second BTSs, the apparatus comprising:
a packet transceiver for exchanging packet data with the mobile station, and transmitting a corresponding reverse control message;
a switch for performing a switching operation for transmission of data to be transmitted to the mobile station, a message to be transmitted to the BSC, and a control message received from the BSC; and
a controller for measuring a reverse load of the BTS using the packet transceiver, calculating a load for a mobile station in a handover state, received from the BSC, and performing reverse control on a mobile station in a non-handover state.

45. The apparatus of claim 44, wherein when a reverse control message to be transmitted to a mobile station in a handover state is received from the BSC, the controller transmits the reverse control to the mobile station by controlling the packet transceiver.

46. The apparatus of claim 45, wherein the reverse control message is a reverse rate control message transmitted to the mobile station in a handover state.

47. The apparatus of claim 46, wherein the reverse control message is an ACK/NACK signal transmitted to the mobile station in a handover state.

48. The apparatus of claim 44, wherein upon receiving a control request for a handover-ended mobile station from the BSC, the controller performs reverse control on the mobile stations in a handover station, including the handover-ended mobile station.

49. The apparatus of claim 45, wherein the controller generates a message for requesting suspension of reverse transmission for a predetermined time, and transmits the generated message through the packet transceiver in order to control the handover-ended mobile station.

50. The apparatus of claim 44, wherein the controller sets up a separate control channel and performs reverse control in order to control the handover-ended mobile station.

51. A method for controlling a mobile station by a base station controller (BSC) in a mobile communication system including a first base transceiver system (BTS), a second BTS being adjacent to the first BTS, a mobile station in a handover region commonly occupied by the first and second BTSs, and the BSC connected to the first and second BTSs, the method comprising the steps of:
the mobile station, transmitting a maximum data rate to BTS
receiving the maximum data rate transmitted by the mobile station, via one of the first and second BTSs; and
determining one of data rates not exceeding the maximum data rate, and transmitting the selected data rate to the first and/or second BTSs.

52. The method of claim 51, further comprising the step of wherein the mobile determines the maximum data rate based on a channel state.

53. The method of claim 52, further comprising the step of wherein the channel state is determined by measuring a strength of signal transmitted from the BTSs over a pilot channel.
